(19) United States
(12) Patent Application Publication
(10) Pub. No.: US 2008/0120070 A1
(43) Pub. Date: May 22, 2008

(54) Automatic Specification Generator for CAD Piping Design

(75) Inventors: Gregory Wayne Miller, Columbus, TX (US); Ryan Michael Bromm, Katy, TX (US); Donald Wayne Nuckels, Sealy, TX (US)

Correspondence Address: LUNDEEN & DICKINSON, LLP, PO BOX 131144, HOUSTON, TX, 77219-1144, US

(73) Assignee: IMAGE CUSTOM ENGINEERING SOLUTIONS, LLC, Houston, TX (US)

(21) Appl. No.: 11/943,108

(22) Filed: Nov. 20, 2007

Related U.S. Application Data
(60) Provisional application No. 60/866,508, filed on Nov. 20, 2006.

(51) Int. Cl. G06F 17/50; G06F 17/30

(52) U.S. Cl. 703/1; 707/1; 707/E17.001

(57) ABSTRACT

This software product is an system for the automatic creation of a specification file in a format compatible with an engineering computer assisted design program (CAD) thereby permitting the rapid and efficient creation of engineering designs, specifically for piping, in accordance with industry recognized standards, and for verifying that the proposed design meets the engineering standards for maximum allowable working pressure and temperature.

### BACKGROUND OF THE INVENTION

The present invention relates to computer assisted engineering drafting method; more specifically, to an automated process system that provides a rapid method for creating the specification files necessary for a computer assisted design and drawing application (CAD) for plant piping design. This process allows the user to select sizes, materials, ratings, connection types, etc. of most standard commodity components through a simple drop down selection process accessed through a simple user screen.

Modern design technology has been vastly improved by the advent of CAD programs for plant piping applications. With the development of products such as AutoCAD®, product of Autodesk, Inc., engineering design is now easier and more sophisticated. CADWorx®, a product of COADE, Inc., is a well known product in the piping and plant design industry. CADWorx provides a plant and process and instrumentation design packages which work well with AutoCAD. The present invention is an add-on to the CADWorx product which allows the automated creation and editing of the specification file used by CADWorx to render a pipe design drawing in accordance with industry standards. These industry standards are committee drafted standards which are deemed the best practices of the industry at the time of adoption. The Chemical Plant and Petroleum Refinery Piping Code are part of a larger code for pressure piping, the ANSI B31. These codes sections are available to the public from the American Society of Mechanical Engineers. Other standards which may also be included in the present system include the ASME Boiler and Pressure Vessel Code. Certain dimensional standards can be found in the American National Standards Institute (ANSI) and American Petroleum Institute (API) standards. Other standards which are incorporated within the standards described above include the American Society for Testing and Materials (ASTM) and the Manufacturers Standardization Society of the Valve and Fittings Industry (MSS). As a result of the multiplicity of standards setting bodies, the design of piping applications can require tedious attention to all of the applicable standards. Use of the present invention can minimize the need to consult multiple sources for standards appropriate for a pipe design project, because these standards are automatically incorporated into the design through the creation and use of the specification file.

Once the appropriate selections are made, the user can create a specification file which is read by the CAD plant design software. Within the CADWorx® system, this file provides the specification data in a particular format and is named with the suffix “.spc”. It is applicants' intent to provide a variety of file formats to work with a variety of pipe design CAD programs available in the market, such as Rebis, PDS, PDMS, AutoPLANT, AutoDesk Plant, Plant 4-D, CADPIPE, SmartPlant, FlexCAD, and nothing contained herein should be construed as a limitation of that intent. The specification file controls the size ranges and materials definitions of all commodity items, and directs the CAD software to the appropriate library files for proper geometric design. Moreover, the existing embodiment works with tables created on a Microsoft Access data base system, using Visual Basic as the primary scripting language. Other relational data base management systems (DBMS) and applications, such as Microsoft SQL Server 2005, Oracle's DBMS, MySQL data base system, or other text editing files could be used as the data file creation to support the current methods, along with other scripting languages such as PERL, Python, and any number of other commonly used programming languages, all in a manner well known in this art. In addition to generating CAD specification files, the user can save a configuration file, thereby allowing the user to—at a future date—import the settings for modification or to use a starting point of a new specification. A report can also be generated which provides summary details of all settings (e.g. in MS Excel®) for design review, approval, and documentation. This software also allows the user to select additional specification files to append to the items selected by the process system or to add specific items to the spec file. These features permit the user to add non-commodity type items that are not covered in the user interface of the system or to provide optional or alternative specifications for use in the engineering design drawings. Finally, this application creates a master file reference to standard parts references and descriptions permitting rapid specification generation using the customer's part number scheme, standard industrial descriptions or other vendor part number schemes with little or no additional effort.

### SUMMARY OF THE INVENTION

The present invention provides a method for creating engineering specifications for use in a CAD program allowing a user to create one or more data files having standard engineering descriptions and specifications for a plurality of standard piping sizes, schedule and pressure ratings of materials, ratings, flange types, connection types, gasket type, valves and valve types, permissible weld gaps, part numbers and cross-reference information specific to the engineering design project; enter information into a user data screen having specification information fields identifying the specification being created and providing specific design criteria useable by a CAD program for an engineering design selected from the one or more data files provided; enter specific design sizes necessary for an engineering design; access the one or more data files from a user data screen having a plurality of pull-down menus, each accessing a particular data field within the one or more data files and each such pull-down menu being identified as pertaining to the characteristic selected; and, automatically create a specification file for importation and use by the CAD program to complete the engineering design drawing.

This method can further allow the user to save the specification file to a disk file and send the specification file to a user application. The user can also use other applications such as a spreadsheet application or a word-processing application to manipulate or use the data for reports, approvals or financial analysis.

The present invention provides a process for generation of a drawing specification file utilizing a computer system having a keyboard, a pointer device, a visual display and storage media for data storage and retrieval for a user to interact with the computer. The computer provides access to a data files stored on said storage media or remotely containing fields for each characteristic of a specific element of an engineering design; and, a computer program resident on the computer system for accessing the data files and enabling visual display of the available data files field information, accepting user input from the keyboard to create a specification file for use with a engineering drawing program, a central processing unit which accepts the user input and the selected data file information and generates a specification file for use with the engineering drawing program.

### BRIEF DESCRIPTION OF THE DRAWINGS

FIG. 1 is a schematic flow diagram of the system.

FIG. 2 is a representative screen shot from the system.

FIG. 2A is another representative subscreen shot of the Sizes pull-down box with alternative sizes selected.

FIG. 3 is a representative screen shot from the system of the Excluded Pipe Sizes.

FIG. 4 is a representative screen shot from the system showing the Flange selection pull-down screen for a single piping size.

FIG. 5 is a representative screen shot from the system showing the Flange selection pull-down screen for a plurality of piping sizes.

FIG. 6 is a representative screen shot from the system showing the gasket type selection for Spiral Gaskets.

FIG. 7 is a representative screen shot from the system showing the gasket type selection for RTJ-type Gaskets.

FIG. 8 is a representative screen shot from the system showing the Additional Items screen resulting from the GUI button.

### DETAILED DESCRIPTION OF A PREFERRED EMBODIMENT

The present invention relates to a system which facilitates the creation of a specification file which is used by a CAD program to complete an engineering design. In this preferred embodiment, the specific application relates to a piping design project and the specific CAD program being used is CADWorx® series of programs from COADE, Inc., although the principles described herein could be applied to any other CAD program which utilizes engineering standards to create a specification for the drawings being created by the program.

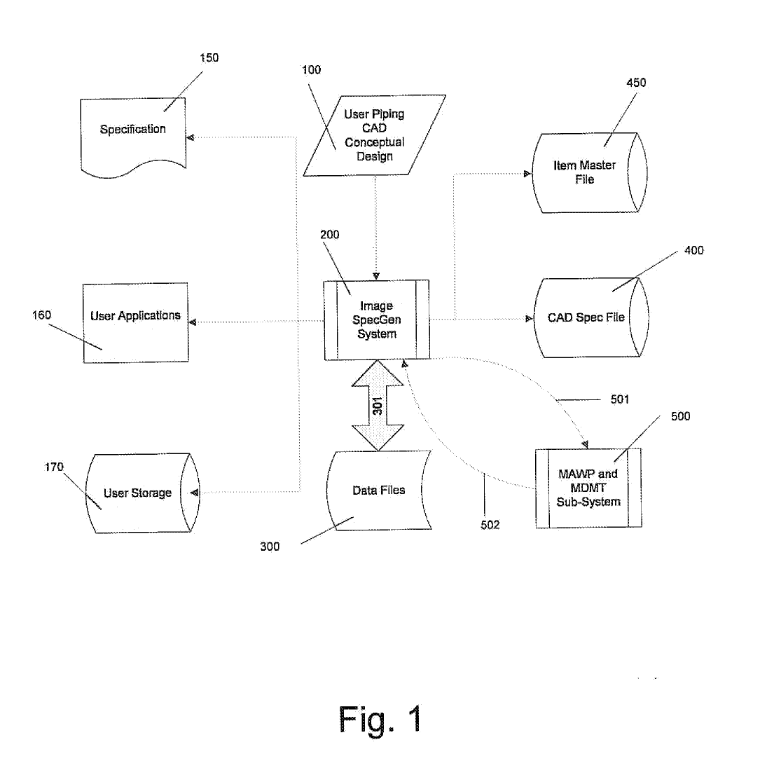

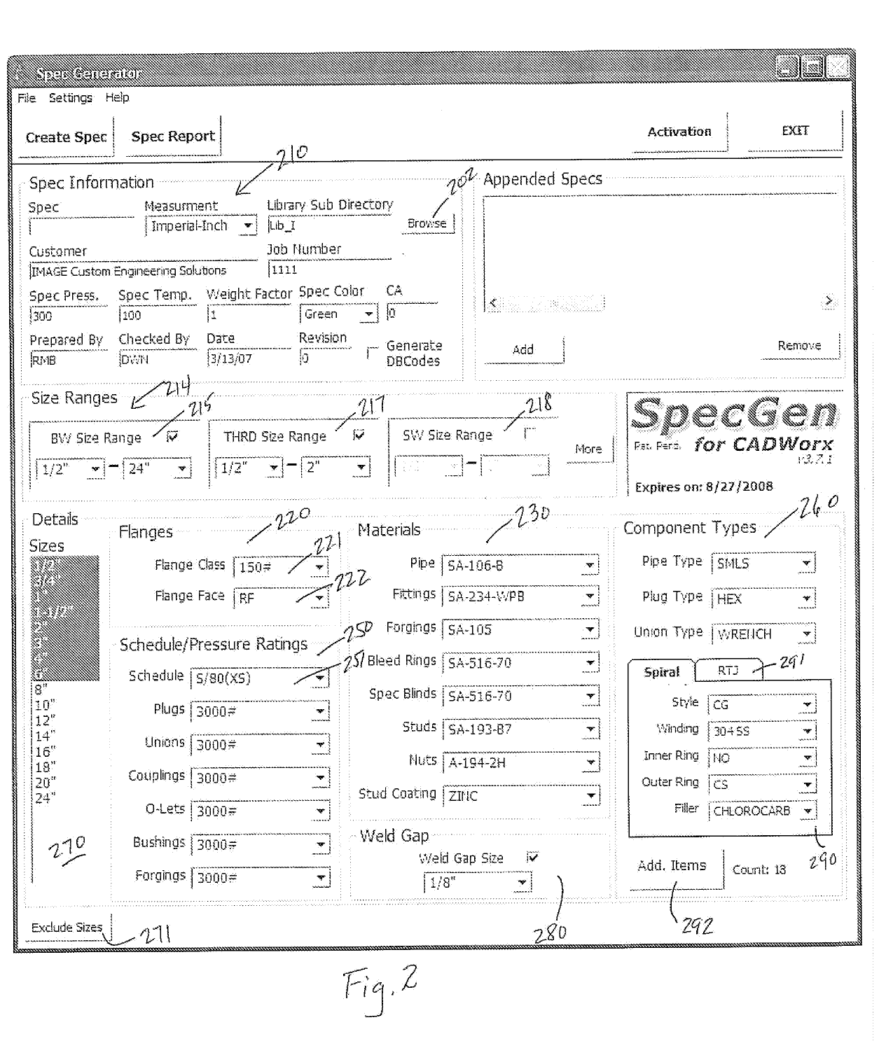

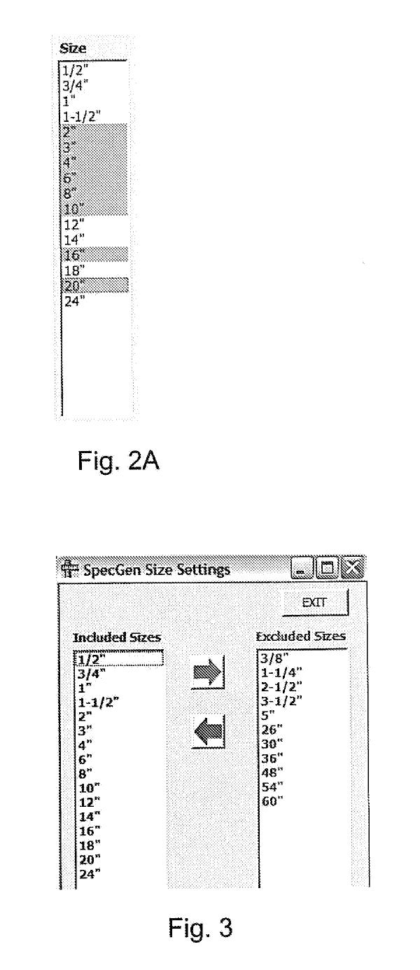

FIG. 1 schematically describes the flow of information and the processing steps for the creation of the specification file. The engineering consultant or inhouse personnel charged with responsibility for the design or extension of a new plant would generate a conceptual design 100 to accomplish the design objectives desired. The engineering staff would enter these conceptual designs into the Image SpecGen application 200 using a graphics user interface (GUI) shown in FIG. 2.

The GUI of FIG. 2 allows the user to first identify the project in the portion of screen 210 thereby permitting the association of this specification file with a given project or portion of project and thereby associate the specification file to be generated with a particular library file having the pertinent information for the selected elements of the design. The Spec Information section of the GUI also allows the user to browse for previously saved specification(s) which may be used or incorporated into the new application using a browse feature 202. Other general information which relates the specific features of the specification file to the CAD job to be completed including a choice of units which can be used, specific pressures, temperatures and weight factors. Finally, an audit trail is created for each specification sheet created by the system by requiring identification of the party preparing the specification file, the party checking the work and the date of creation of the file by appropriate data entry fields shown within the Spec Information section 210.

The GUI of FIG. 2 also permits the user to interactively select from pull down boxes for each of the appropriate specification piping elements which may be required by the design contemplated. For example, FIG. 2 permits the user to input the range of sizes of butt weld piping 215 (BW) contemplated in the design. Similarly, the user can select and input into the specification file a range of sizes for thread connected piping 217 (THRD) and socket weld connected piping 218 (SW) contemplated by the design engineer.

The GUI also permits the user to chose the Flange class and face configuration 220, the materials standards for each type of element of the piping design 230, the schedule/pressure ratings for each type of element in the proposed design 250, the component types 260 including the gasket types 290 for each connection requiring such, along with the weld gap 280 permitted by the design engineer.

The creation of specification files with this level of detail is often done by opening a simple text editor and inputting each of the data elements in a specific format. This is not only tedious and time-consuming, but often leads to errors from simple typographic mistakes or omission of specific elements required to be specified for the CAD operator. The present invention automates the creation of this file and provides sufficient safeguards to the files created to allow review and approval before used in the creation of the drawings for the pipe design project. As more fully shown in FIG. 2, the following elements are clearly presented to the user for automatic creating of the specification file.

### Main Interface Dialog

The Main Interface Dialog box, FIG. 2, is the main interface screen for the SpecGen 200, of FIG. 1. This GUI prompts for and obtains user input in the following manner.

### Spec Information

Spec Information 210 consists of a series of text boxes where permitting insertion of useful descriptive text for future reference. Additionally, the user can associate the correct file path to the CADWorx library file subdirectory in instances where the user has relocated the subdirectories to a non-standard location such as a network drive. The color drop-down box allows the user to set the color that they wish to use for drawing this spec. The measurement drop-down allows the user to select the units specified for use in the design.

### Size Ranges

The Size Ranges area 214 allows the user to specify which size ranges are applicable to butt-welded, threaded, and socket-welded components of piping within the system. If the designer wishes only to allow use threaded components 217 in ½″-2″ range with no socket-weld components 218 allowed and with butt-welded components 215 from ½″-24″ with no components larger than 24″ allowed, the settings would be set by the user in the GUI as follows.

### Size

The piping Size Ranges area 270 allows the user to select the range of sizes for the piping design selected. To select a size range, standard selection techniques well known to all users of standard operating systems are used to select the designed range; such as holding “shift” and selecting a range by clicking to sizes and all sizes in between or “control” to pick multiple single entities. Once selected, the sizes in the selection set will become highlighted and thus any changes made to the other settings will be applied to this size range. The example in FIG. 2 shows the user has selected by highlighting 270 a sizes ½″-6″. Any setting selected will be applied to this range set. If, for example, a designer desired to limit the size to 2″-10″ and 16″ and 20″ only, she could choose those particular sizes by shift-clicking on the particular sizes in the pull-down menu 270, as more fully shown in FIG. 2A. Changes made to the other settings will be applied to this size range automatically.

In cases where different settings for the above have been assigned based on different size ranges, when the user selects a sizes range that includes both settings, the word “VARIES” will be displayed in the drop-down box to indicate that the setting varies across the size range currently selected.

### Exclude Sizes

The Exclude Sizes button 271 is found right below the Size Area 270 and allows the user to choose any size that are not to be made available in the size list. This switch may be activated irrespective of the Size ranges selected. For example, if one wanted to make sure that ⅜″, 1¼″, 2½″, 3½″, and 5″ pipe sizes are removed from the choices available, the size can be excluded through the action caused by the dialog box which is toggled with the Exclude Sizes button. The dialog box is shown in FIG. 3 after clicking on the Exclude Sizes box 271, which then reflects the sizes previously listed but excluded from consideration.

### Flanges

The Flanges area 220 of the GUI of FIG. 2 assigns the Flange Class 221 pressure rating and face type 222 of the flanges desired to be drawn. Selection is made through the drop-down boxes. The FIG. 2 shows the user has selected 150# RF type flanges for this spec. In situations where different settings have been assigned based upon different size ranges, when the user selects a size range that includes more than one setting, the word “VARIES” will be displayed in the drop-down box to indicate that the setting varies across the size ranges currently selected. Thus, it is important to select all sizes first before setting the flange sizes.

### Schedule/Pressure Ratings

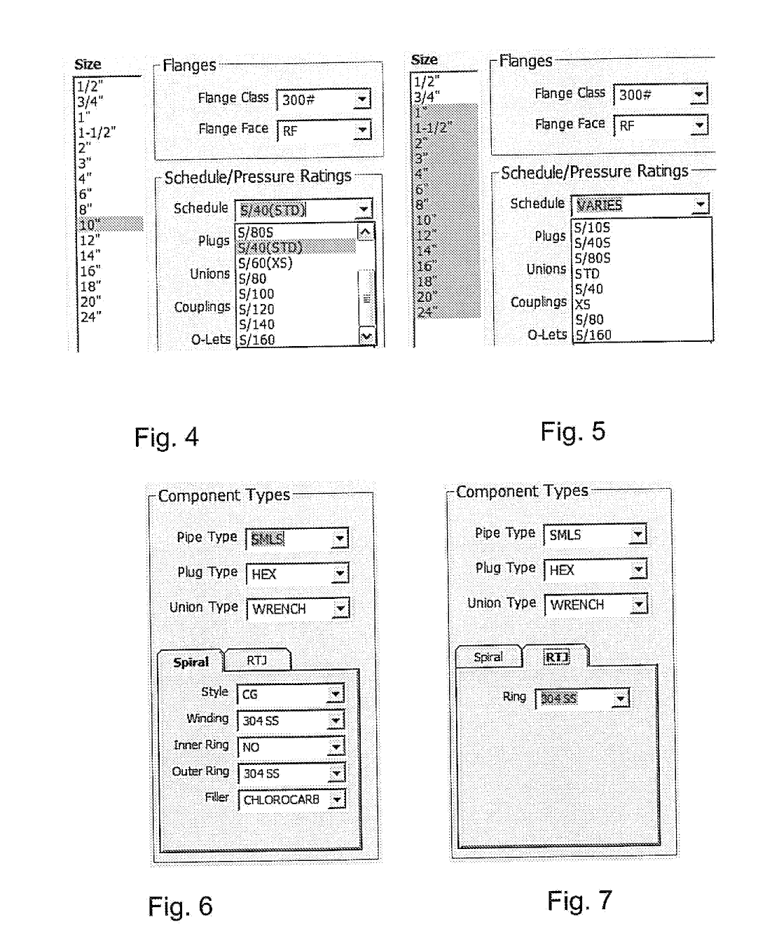

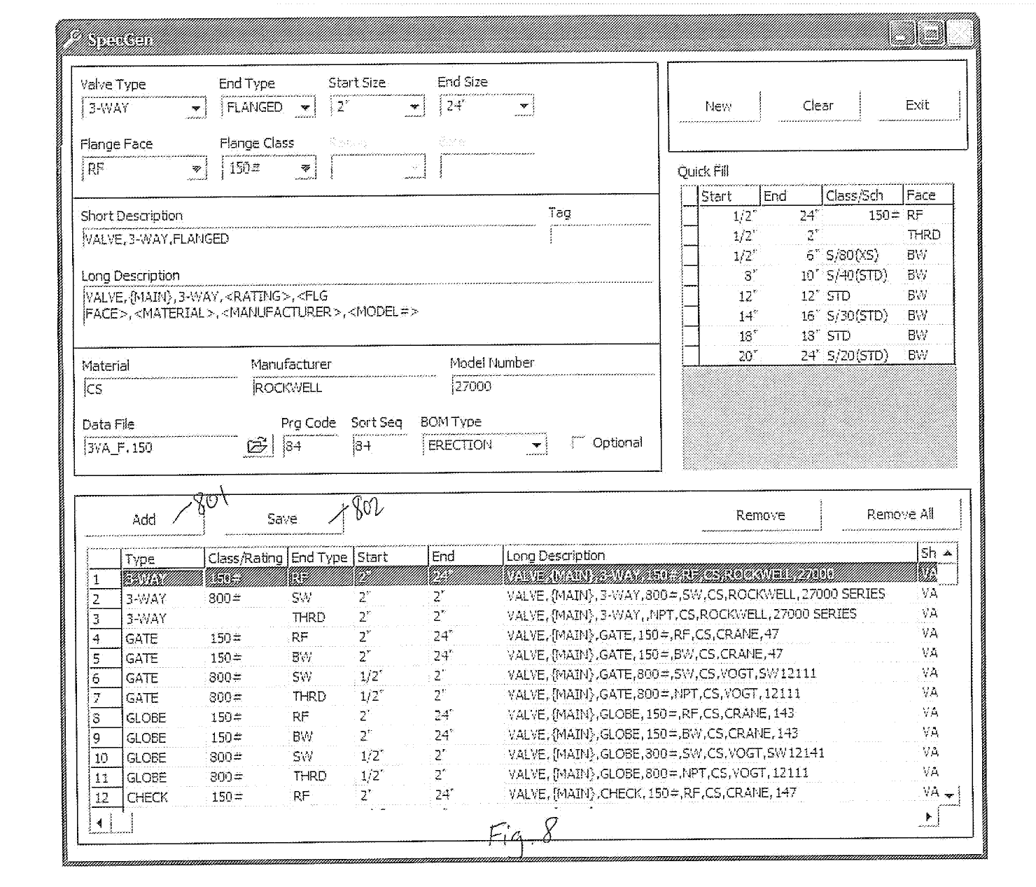

The Schedule/Pressure ratings area 250 of the GUI, FIG. 2, defines the Schedules and Pressure ratings of components. The Schedule drop-down box 251 sets the schedule of the pipe desired. The user must select the size range that applies since the schedules listed are only those schedules that are available in the entire size range selected. For example, if one selects only 10″ as shown in FIG. 4, the designer would be presented with many more selection possibilities than if he had selected 1″-24″ (right and below) because not all sizes are available to all the selections and are thus excluded.

The pressure ratings drop-down boxes are used to define the pressure ratings of certain threaded and socket welded components. In certain drop-down boxes, a value of “not permitted” is displayed (not shown in this view). This excludes these items from being included in the generated spec and thus insure that such parts are not inadvertently specified and used.

In cases where different settings have been assigned based on different size ranges, the user can select a size range that includes both settings. In that eventuality, the word “VARIES” will be displayed in the drop-down box to indicate that the setting varies across the size range currently selected.

### Materials

The materials area 230 of FIG. 2 GUI facilitates the designation of the material specification for each element from a type of material allowed for each different type of specified component. Again, in cases where different settings for materials have been assigned based on different size ranges specified, if the user selects a size range that includes multiple settings, the word “VARIES” will be displayed in the drop-down box to indicate that the setting varies across the size range currently selected.

### Weld Gaps

The weld gaps 280 permits the definition of the acceptable weld gap dimension when if using CADWorx's weld gaps and is especially useful if using the Auto Weld Gap Feature. This allows the user to specify different size weld gaps based on size. In cases where weld gaps are not used, you can un-select the check box and the weld gap standard will not be added to the spec. FIG. 2 shows an example 280 where the user has selected ⅛″ weld gaps. In cases where different settings for the above have been assigned based on different size ranges, if the user selects a sizes range that includes both settings, the word “VARIES” will be displayed in the drop-down box to indicate that the setting varies across the size range currently selected.

### Component Types

The Component Types area 260 of the GUI, in FIG. 2, is used to define additional details for certain types of components. These details are assigned by selecting the appropriate item from the drop-down box, or in the case of gasket details 290, by selecting the appropriate flange gasket-type tab and then selecting the appropriate details. If the user has selected a spiral-wound type gasket by way of example as shown below, the area 290 will show all the appropriate detail. The details shown are different from those available for an RTJ type gasket tab (right and below).

Additionally, another feature allows the user to click on the GUI button 292 for “Add. Items” which opens a form FIG. 8 permitting the entry of a desired valve (and other desired additions) without being limited by the preset sizes, ratings and descriptions provided by the remaining user buttons. The user can then enter the Start size, the End size, a description, a program code, data file and sort sequence compatible with the existing spec file system. This permits the system to accept unique user-required inputs into the spec file in a manner compatible with the overall use of the system. FIG. 8 is a screen shot of the subsidiary screen which is activated when the user pushes the “Add.Itmes” button on the GUI. The user then fills the GUI screen presented with the specification desired, and when clicking button 801 on the form, the information filed in the form is added to the specification file created. When the user clicks on the added row in the lower half of FIG. 8, the information is placed into the information fields above where it may then be changed. If the user is then satisfied with the specification information, the user would click the Save button 802 and the file would be changed to reflect the edited information.

### Appended Specs

The Appended Specs area 219 of FIG. 2 allows additional specs to be appended to the items specified in the SpecGen system 200 of FIG. 1. This permits the addition of elements not covered by the commodity elements shown in FIG. 2 on the pull down menus. A user can combine other previously completed specification with the current specification created by the SpecGen system. To add a spec, a user can select the “Add” button in the Additional Specs area and browse to the previously created spec file. Upon selection, the user will be provided a path to the selected file listed in the additional Specs window. It is thus possible to layer multiple additional specs in this manner extending the scope of design spec automatic generation accomplished by this system.

Referring now to FIG. 1 again, the SpecGen application 200 also permits the export of a file to a standard spreadsheet application 160; for example, but without limitation, to EXCEL®, a well-known spreadsheet product offered by Microsoft Corp. Once exported using the standard .xls format, the specification details may be reviewed by the design team and approved for completeness and accuracy before proceeding to the creation of the piping design. The specification file can also be printed to a written report 150 in a format provided by the user for review and approval. This audit trail also allows the archival of specification for future reference if needed for liability purposes or reference material for similar types of designs. Since standards may change over time, the specific design characteristics for a given specification file can be permanently preserved with sufficient detail to reflect the actual design made. The output from the SpecGen system 200 can also be preserved on user disk storage 170 as shown in FIG. 1.

Data files 300 containing all of the industry standards for piping design is intended to be constantly maintained with the latest adopted standards. This will permit the use of the system for piping design without risk of using stale or disapproved design standards for new projects. The use of this data file system allows the maintenance with minimal cost while at the same time providing timely updating of standards by the design team. For example, if the specification file is accessed by the CAD program for a design, changes in the standards which are reflected in the standards data files 300 will reflect changes “on the fly” in the CAD design through the data link 301, if the design team chooses to run the specification file 400 back though the application 200. Thus, the final design for piping can be checked against the latest issued standards with little or no delay by merely rerunning the system through the system of the present invention. The standard information shown in the drop down boxes of FIG. 2 reflects the data file information in data files 300.

The system can also provide a subsystem 500 for checking the engineering design and the specification file generated by this system against the maximum allowable working pressure (MAWP) standards for each element of the proposed design and for the minimum design metal temperature (MDMT). The subsystem 500 takes data from the generated spec file 501 and compares the designed pressure and temperature for the specified element against the rated elements. If the proposed specification element does not meet or exceed the rated standards, the element identified in data sent to the system 502 and a special exception file within the SpecGen system is created for review by the design engineer.

Finally, the SpecGen system 200 can create an item master file 450 for delivery to the user containing a user accessible list of items by standard part number. The standard part number of this item master file 450 is automatically supplied from the SpecGen system in a format available for direct use by the user of the system in a bill of materials processing system or the like. The standard part number can be isomorphically mapped to a user-specific part numbering system for consistency with the user's internal parts tracking software applications in a manner well known in the data processing field.

Numerous embodiments and alternatives thereof have been disclosed. While the above disclosure includes the best mode belief in carrying out the invention as contemplated by the inventors, not all possible alternatives have been disclosed. For that reason, the scope and limitation of the present invention is not to be restricted to the above disclosure, but is instead to be defined and construed by the appended claims.

What is claimed is:

1. A method for creating engineering specifications for use in a CAD program comprising:
creating one or more data files having standard engineering descriptions and specifications for a plurality of standard piping sizes, schedule and pressure ratings of materials, ratings, flange types, connection types, gasket type, valves and valve types, permissible weld gaps, part numbers and cross-reference information specific to the engineering design project;
entering information into a user data screen having specification information fields identifying the specification being created and providing specific design criteria useable by a CAD program for an engineering design selected from the one or more data files provided;
entering specific design sizes necessary for an engineering design;
accessing the one or more data files from a user data screen having a plurality of pull-down menus each accessing a particular data field within the one or more data files and each such pull-down menu being identified as pertaining to the characteristic selected; and,
automatically creating a specification file for importation and use by the CAD program to complete the engineering design drawing.

2. The method of claim 1 further comprising saving the specification file to a disk file.

3. The method of claim 1 further comprising sending the specification file to a user application.

4. The method of claim 1 further comprising verifying that a physical rating for each element of the specification file are at least equal to the design limits for temperature and pressure for the engineering design.

5. The method of claim 1 further comprising generating an item master file.

6. The method of claim 3 wherein the user application is a spreadsheet application.

7. The method of claim 3 wherein the user application is a word-processing application.

8. A process for generation of a drawing specification file comprising:
a computer system having a keyboard, a pointer device, a visual display and storage media for data storage and retrieval for a user to interact with the computer;
a data file stored on said storage media containing fields for each characteristic of a specific element of an engineering design; and,
a computer program resident on the computer system for
accessing the database and enabling visual display of the available data file field information,
accepting user input from the keyboard to create a specification file for use with a engineering drawing program,
a central processing unit which accepts the user input and the selected data file information and generates a specification file for use with the engineering drawing program.

9. The process of claim 8 further comprising the generation of an item master file providing unique part numbers for each element of the engineering design.

10. The process of claim 8 wherein the data file is contained in a relational database management system.

11. The process of claim 8 wherein the data file is a text file.
